(19) United States
(12) Patent Application Publication
(10) Pub. No.: US 2009/0180771 A1
(43) Pub. Date: Jul. 16, 2009

(54) Camera for shooting like a professional

(76) Inventors: Ming-Chang Liu, San Jose, CA (US); Chuen-Chien Lee, Pleasanton, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/013,984

(22) Filed: Jan. 14, 2008

(51) Int. Cl. G03B 15/02; G03B 7/00

(52) U.S. Cl. 396/61; 396/65

(57) ABSTRACT

An imaging system acquires an image using focal point and field depth information. The system receives focal point and field information via a user interface and analyzes the image based on the focal point and field depth information to calculate characteristics of the content of the image. In addition, the system automatically determines the image exposure based on the characteristics. Furthermore, the system determines the appropriate aperture and exposure based on the field depth information.

### FIELD OF INVENTION

This invention relates generally to image acquisition, and more particularly allows for the general public to capture the best pictures that they can hardly achieve.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright©2006, Sony Electronics, Incorporated, All Rights Reserved.

### BACKGROUND

Point and shoot digital cameras are popular because these cameras are very easy to use. These cameras do not require unnatural tuning or setup. However, pictures taken with point and shoot digital camera tend to be fiat because the entire image is in focus. These types of images lack the pleasing shallow depth of field (or “field depth”) that has the image subject in focus with a blurring of the image background. Setting the camera aperture and shutter speed parameters typically controls the field depth. Camera vendors tend to compensate for this shortcoming by offering scene selection modes that allow a user to choose a scene before taking a shot. Typical scene selection modes are snow, twilight, portrait, scenery/landscape, building, night scene, etc. These scene selection modes modify camera input parameters such as aperture, shutter speed, etc. and use different parameters for image post-processing. However, the scene selection modes are awkward to use and the parameters changes are applied to the entire image. Furthermore, the user may set the scene for one picture, say a portrait, and forget the change the scene mode for a different type of image, for example a landscape picture. In addition, a user switching between different scene selection modes may miss the timing for a good image shot. Some cameras offer aperture and shutter priority modes, which allow the user to set the aperture or shutter speed and the camera would automatically set the other parameters. However, because the user has to set the initial parameter without feedback on how the shot would look, aperture and shutter speed mode are difficult to use.

On the other end of the spectrum, digital single lens reflex (DSLR) cameras offer a full flexibility in controlling the camera, which allow the user to set the desired depth of field through the combination of aperture and shutter speed. However, DSLR cameras are complex to use to user accustomed to simplicity of point and shoot. Even with the flexibility of the DSLR cameras, most DSLR users acquire images using the fully automatic modes, in which the camera sets the image acquisition parameters.

In addition, lighting by a camera flash can affect image quality. A stronger flash can illuminate a dark subject, but too much flash will wash out the image details. Inappropriate flash makes the scene look either too warm or too cold, or generally unnatural. Attempts in the art to allow the user to manually set a weak, medium or strong flash level, are not successful, because the user may forget to change the setting when the flash setting needs to change from weak to strong, etc.

A camera should offer the simplicity of a point and shoot camera, but allow the user to easily to adjust the camera parameters to take pictures with automatic scene selection and with an easy way to set the field depth of the subject.

### SUMMARY

An imaging system acquires an image using focal point and field depth information. The system receives focal point and field information via a user interface and analyzes the image based on the focal point and field depth information to calculate characteristics of the content of the image. In addition, the system automatically determines the image exposure based on the characteristics. Furthermore, the system determines the appropriate aperture and exposure based on the field depth information.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### BRIEF DESCRIPTION OF THE DRAWINGS

The present invention is illustrated by way of example and not limitation in the figures of the accompanying drawings in which like references indicate similar elements.

FIG. 1 illustrates one embodiment of an imaging system.

FIG. 2 illustrates one embodiment of an imaging system user interface.

FIG. 3 is a flow chart of one embodiment of a method that determines the appropriate image acquisition settings based on the focal point and focal depth.

FIG. 4 is a block diagram illustrating one embodiment of an image device control unit that determines optimal image settings based on the inputted focal point and focal depth.

FIG. 5 is a diagram of one embodiment of an operating environment suitable for practicing the present invention.

FIG. 6 a diagram of one embodiment of a computer system suitable for use in the operating environment of FIG. 3.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

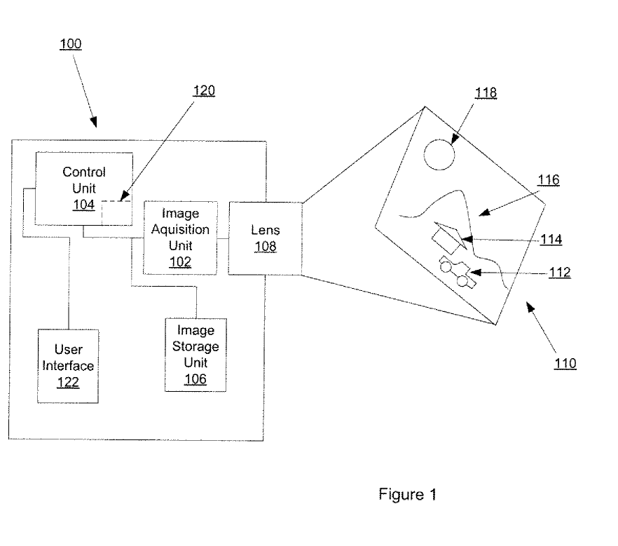

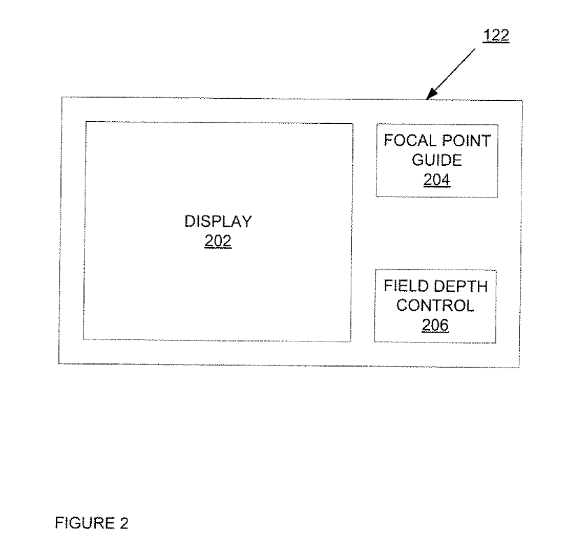

FIG. 1 illustrates one embodiment of an imaging system 100 that captures an image of a three dimensional spatial scene 110. References to an image or a picture refer to an image of a three dimensional scene captured by imaging system 100. Imaging system 100 comprises an image acquisition unit 102, a control unit 104, an image storage unit 106, lens 108, and user interface 122. Imaging system 100 may be a digital still camera, video camera, surveillance camera, robotic vision sensor, image sensor, etc. Image acquisition unit 102 captures an image of scene 110 through lens 108. Image acquisition unit 102 can acquire a still picture, such as in a digital still camera, or acquire a continuous picture, such as a video or surveillance camera. Control unit 104 typically manages the image acquisition unit 102 automatically and/or by operator input. Control unit 104 configures operating parameters of the image acquisition unit 102 and lens 108 such as the lens focal length, f, the aperture of the lens, A, lens focus, and (in still cameras) the lens shutter speed. In addition, control unit 104 may incorporate an image setting unit 120 (shown in phantom) that sets the image acquisition parameters. The image(s) acquired by image acquisition unit 102 are stored in the image storage 106. User interface 122 allows a user to control imaging system 100 and to view scene 110 on a display. User interface 122 is further described in FIG. 2.

FIG. 2 illustrates one embodiment of an imaging system user interface. In FIG. 2, user interface 122 comprises display 202, focal point guide 204, and field depth control 206. In one embodiment, display 202 comprises an image display that displays scene 110, imaging control parameters and/or stored images. In addition, display 202 can show a preview of the image to be acquired based on the current set of input and post-processing parameters. Focal point guide 204 is a control that allows the user to set the focal point of the image. A focal point is the part of the image that user is instructing imaging system 100 to focus on. The focal point can be close object, in the case of the portrait or far away for landscape images. In one embodiment, focal point guide is joystick, cursor, etc., that allows the user to point to any part of the image. User interface 122 displays a cursor that shows the current focal point position. Because the focal guide control covers the entire image, the focal point can be at any point of the image. In addition, setting the focal point speeds up the auto-focusing mechanism of imaging system 100.

Field depth control 206 allows the user to control the field depth for the picture. In one embodiment, the field depth is based on the focal point set by the user. The field depth is the distance in the front of and beyond the subject that is in focus. The field depth can be small in which the image subject is in focus and the rest of the picture is blurred. This is useful for portrait images where the user typically intends the portrait subject to be the sole focus of the image. On the other hand, the field depth can be large, in which the entire image is in focus. Large field depth is particularly useful for landscape images, in which the whole scene is the subject of the image.

In one embodiment, the field depth control 206 is a control that allows the user to select between a very shallow to a very large field depth. The field depth control 206 can be a dial, slider, buttons or other input device that allows a user to select more or less field depth. Alternatively, field depth control 206 can be an on-screen controller on display 202. In one embodiment, the results of the field depth selection are displayed as the in real-time. In this embodiment, display 202 displays the image to be captured based on an initial setup. The user can increase or decrease field depth with field depth control 206. The field depth change is reflected in image displayed in display 202. The field depth change can be displayed by changing the aperture appropriately, image processing, etc. In this embodiment, additional image processing may be applied in order to make the field depth adjustment more visible on display 202. In one embodiment, if the field depth increase from field depth control 206 is equivalent to one F-stop aperture decrease, control unit 104 determines this aperture reduction and increases the shutter speed one stop to achieve the preferred field depth and keeping the same exposure. Because field depth determines the focus area around the focal point, selecting the field depth and the focal point lets the user what part of the image is in focus and which part of the image blurred out.

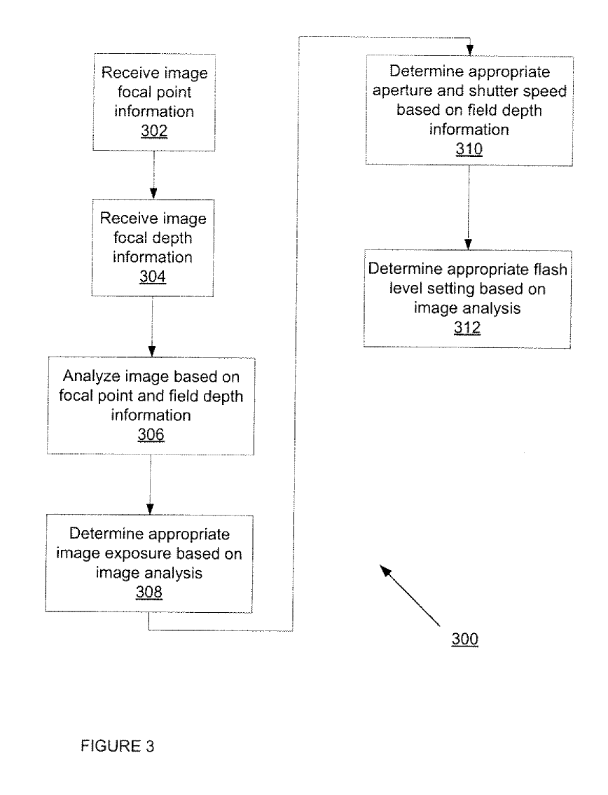

FIG. 3 is a flow chart of one embodiment of a method 300 that determines the appropriate image acquisition settings based on the focal point and focal depth. In one embodiment, image setting unit 120 executes method 300 to determine the appropriate parameters for acquiring an image. In FIG. 3, at block 302, method 300 receives the focal point information. As described above, in one embodiment, focal point information is the point of the image where imaging system 100 focuses on. In one embodiment, the focal point information is the x and y pixel coordinates of the image set by the focal point control. In one embodiment, method 300 receives the focal point information form focal point control 204.

At block 302, method 300 receives the field depth information. As in known in the art, field depth is the range of reasonable sharp focus in an image. Field depth is based on focal length, subject distance, focal point, and aperture. In one embodiment, the field information is the field depth information received from field depth control 206 as described in FIG. 2 above. In one embodiment, method 300 receives the field depth information from Field Depth Control 206. In this embodiment, field depth information comprises aperture f-stops or other information known in the art relating to field depth.

At block 304, method 300 automatically analyzes the image based on the focal point information and the image content. In one embodiment, method 300 analyzes the image to calculate the characteristics of the contents of the image. In one embodiment, image characteristics can be optimal setting for the image, such as aperture, shutter speed, scene profile, additional color, focus and surroundings, distance, reflectance of the surface, and other image characteristics known in the art. In one embodiment, method 300 analyzes the image to determine what type of scene profile to set for the image. In this embodiment, method 300 analyzes the scene relative to the focal point and field depth using algorithms known in the art. In one embodiment, providing the focal point assists these algorithms quickly analyze the scene and determine an appropriate initial step for capturing the picture. In one embodiment, method 300 analyzes content of the image, such as the lighting, colors, and distance of the subject determined by the focal point and field depth. In this embodiment, the focal point signals the user's intention and the priority of the image. In another embodiment, method 300 selects the image scene mode based on image scene analysis. For example, if the subject of the image is relatively close with a shallow field depth, method 300 selects the portrait mode. In this example, the portrait mode would setup the camera input and post-processing parameters that is optimal for a portrait scene. As the scene analysis and/or scene selection is done for each acquired image, the user does not need to remember to set the scene selection or worry about applying the wrong scene for the wrong type of image.

At block 308, method 300 determines the appropriate image exposure based on the image characteristic analysis. Image exposure means how much light imaging acquisition unit 102 will receive when acquiring the image. Increasing the exposure, gives a lighter image, while decreasing the exposure gives a darker image. Method 300 determines the exposures by determining the lens aperture and shutter speed settings. In one embodiment, method 300 allows for an increased image exposure the exposure by determining a larger aperture (e.g., using a lower f-stop value on the lens) and/or a lower shutter speed. Both ways allow more light to fall on imaging acquisition unit 102. In contrast, method 300 lowers the exposure by using a smaller aperture (e.g. using a higher f-stop lens value) and/or using a higher shutter speed. In one embodiment, method 300 determines the appropriate image exposure by determining the appropriate aperture and shutter speed for an image based on methods known in the art. In another embodiment, method 300 determines adjusted parameters based upon the image scene analysis and the preferred field depth. For example, if method 300 detects a twilight or night scene, method 300 determines an increased exposure by increasing the aperture and/or lowering the shutter speed.

Returning to FIG. 3, at block 310, method 300 determines the appropriate aperture and shutter speed based on field depth information. In one embodiment, the user selects a small field depth for the subject. Method 300 determines a shallow field depth for the image by using a larger aperture while reciprocally increasing the shutter speed. On the other hand, if the user indicates a large field depth, method 300 uses a small aperture (larger f-stop value) and a relatively slow shutter speed. The reciprocity of increasing the aperture/increasing the shutter speed or lowering the aperture/lowering the shutter speed preserves the exposure set in block 308. For example, if method 300 receives a one f-stop aperture adjustment as part of the field depth information in block 302, method 300 makes a reciprocal one-stop shutter speed adjustment in order to maintain the same level of exposure. Based on blocks 308 and 310, method 300 determines the appropriate aperture and shutter speed for the image. In another embodiment, method 300 determines the appropriate International Organization of Standardization (ISO) speed rating according to algorithms known in the art.

Returning to FIG. 3, at block 312, method 300 determines the appropriate flash level setting based on the image characteristics. In one embodiment, method 300 automatically determines the optimal strength of the flash based on the focus and the surroundings, distance, scene, reflectance of surface, and other properties affected by the flash setting. Flash setting refers to the strength of flash used to illuminate the subject with a light controlled by the camera. A stronger flash can illuminate a dark subject, but too much flash will wash out the image details, or make the scene generally unnatural. Automatically detecting the proper flash setting allows the use to not have to remember to set the flash. In one embodiment, method 300 determines a weaker flash setting when the subject is relatively close, while method 300 would cause a stronger flash for a subject that is further away. In another embodiment, method 300 uses a weaker flash for shiny surface that more strongly reflect the light from the flash and uses a stronger flash for surfaces that have a stronger absorbance of the flash. In another embodiment, method 300 determines flash settings for multiple flashes with different and/or the same strengths

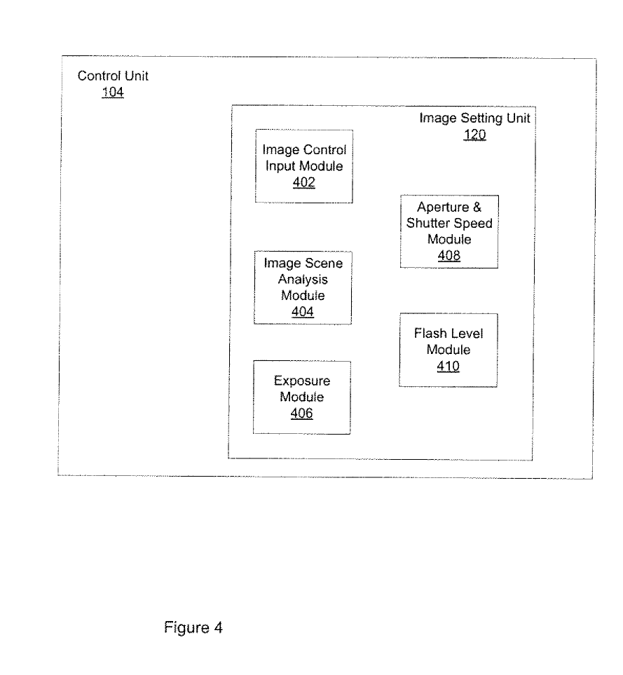

FIG. 4 is a block diagram illustrating one embodiment of an image device image control unit 104 that determines optimal image settings based on the scene analysis, inputted focal point and focal depth in accordance with the operation described in FIG. 3 above. In embodiment, image control unit 104 contains image setting unit 120. Alternatively, image control unit 104 does contain image setting unit 120, but is coupled to image setting unit 120. Image setting unit 120 comprises image control input module 402, image scene analysis module 404, exposure module 406, field depth module 408, and flash level module 410. Image control input module 402 receives the focal point and field depth information as illustrated in FIG. 3, blocks 302-4. Image scene analysis module 404 analyzes the scene based on the focal point information as described in conjunction with FIG. 3, block 306. Exposure module 406 determines the appropriate exposure based on the image scene analysis as illustrated in FIG. 3, block 308. Field depth module 310 determines the appropriate aperture and shutter speed based on the field depth information as described in conjunction with FIG. 3, block 310. Flash level module determines the appropriate flash level setting based on the image scene analysis as described in conjunction with FIG. 3, block 312.

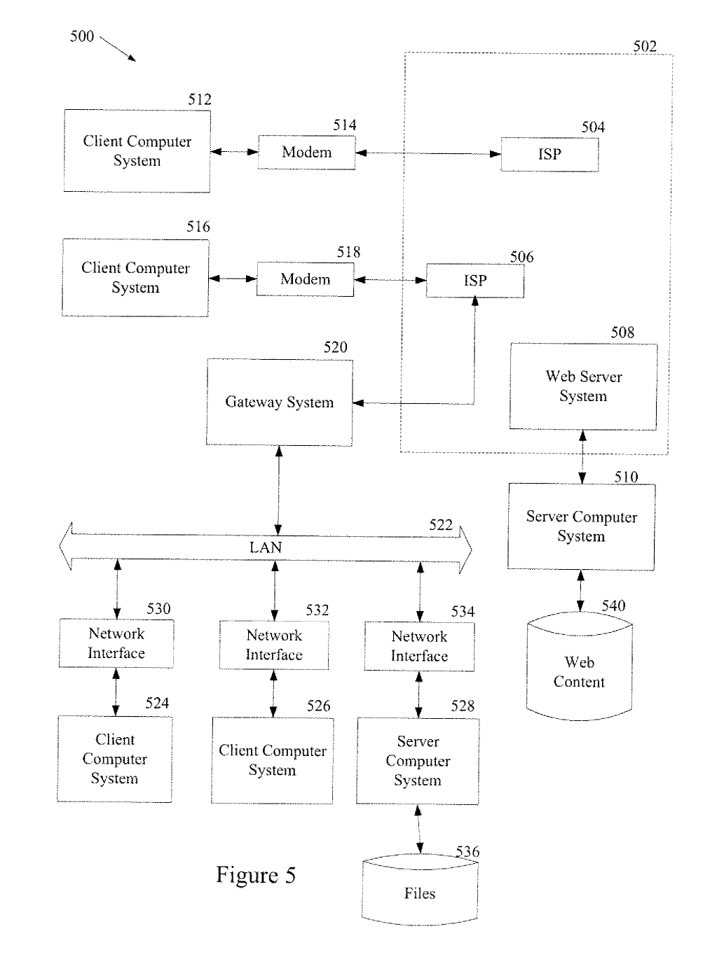

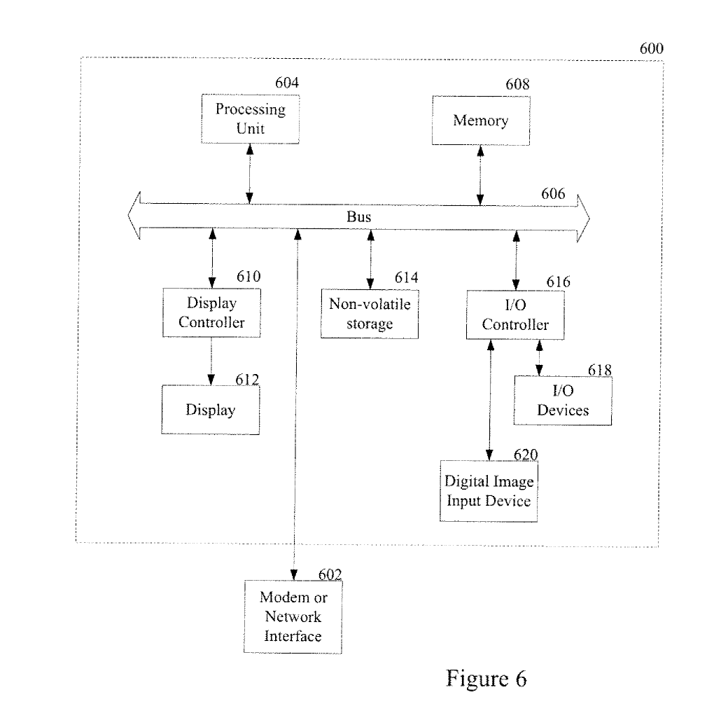

The following descriptions of FIGS. 5-6 is intended to provide an overview of computer hardware and other operating components suitable for performing the methods of the invention described above, but is not intended to limit the applicable environments. One of skill in the art will immediately appreciate that the embodiments of the invention can be practiced with other computer system configurations, including hand-held devices, multiprocessor systems, microprocessor-based or programmable consumer electronics, network PCs, minicomputers, mainframe computers, and the like. The embodiments of the invention can also be practiced in distributed computing environments where tasks are performed by remote processing devices that are linked through a communications network, such as peer-to-peer network infrastructure.

In practice, the methods described herein may constitute one or more programs made up of machine-executable instructions. Describing the method with reference to the flowchart in FIG. 3 enables one skilled in the art to develop such programs, including such instructions to carry out the operations (acts) represented by logical blocks on suitably configured machines (the processor of the machine executing the instructions from machine-readable media). The machine-executable instructions may be written in a computer programming language or may be embodied in firmware logic or in hardware circuitry. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine causes the processor of the machine to perform an action or produce a result. It will be further appreciated that more or fewer processes may be incorporated into the methods illustrated in the flow diagrams without departing from the scope of the invention and that no particular order is implied by the arrangement of blocks shown and described herein.

FIG. 5 shows several computer systems 500 that are coupled together through a network 502, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 502 is typically provided by Internet service providers (ISP), such as the ISPs 504 and 506. Users on client systems, such as client computer systems 512, 516, 524, and 526 obtain access to the Internet through the Internet service providers, such as ISPs 504 and 506. Access to the Internet allows users of the client computer systems to exchange information, receive and send e-mails, and view documents, such as documents which have been prepared in the HTML format. These documents are often provided by web servers, such as web server 508 which is considered to be “on” the Internet. Often these web servers are provided by the ISPs, such as ISP 504, although a computer system can be set up and connected to the Internet without that system being also an ISP as is well known in the art.

The web server 508 is typically at least one computer system which operates as a server computer system and is configured to operate with the protocols of the World Wide Web and is coupled to the Internet. Optionally, the web server 508 can be part of an ISP which provides access to the Internet for client systems. The web server 508 is shown coupled to the server computer system 510 which itself is coupled to web content 540, which can be considered a form of a media database. It will be appreciated that while two computer systems 508 and 510 are shown in FIG. 5, the web server system 508 and the server computer system 510 can be one computer system having different software components providing the web server functionality and the server functionality provided by the server computer system 510 which will be described further below.

Client computer systems 512, 516, 524, and 526 can each, with the appropriate web browsing software, view HTML pages provided by the web server 508. The ISP 504 provides Internet connectivity to the client computer system 512 through the modem interface 514 which can be considered part of the client computer system 512. The client computer system can be a personal computer system, a network computer, a Web TV system, a handheld device, or other such computer system. Similarly, the ISP 506 provides Internet connectivity for client systems 516, 524, and 526, although as shown in FIG. 5, the connections are not the same for these three computer systems. Client computer system 516 is coupled through a modem interface 518 while client computer systems 524 and 526 are part of a LAN. While FIG. 5 shows the interfaces 514 and 518 as generically as a “modem,” it will be appreciated that each of these interfaces can be an analog modem, ISDN modem, cable modem, satellite transmission interface, or other interfaces for coupling a computer system to other computer systems. Client computer systems 524 and 516 are coupled to a LAN 522 through network interfaces 530 and 532, which can be Ethernet network or other network interfaces. The LAN 522 is also coupled to a gateway computer system 520 which can provide firewall and other Internet related services for the local area network. This gateway computer system 520 is coupled to the ISP 506 to provide Internet connectivity to the client computer systems 524 and 526. The gateway computer system 520 can be a conventional server computer system. Also, the web server system 508 can be a conventional server computer system.

Alternatively, as well-known, a server computer system 528 can be directly coupled to the LAN 522 through a network interface 534 to provide files 536 and other services to the clients 524, 526, without the need to connect to the Internet through the gateway system 520. Furthermore, any combination of client systems 512, 516, 524, 526 may be connected together in a peer-to-peer network using LAN 522, Internet 502 or a combination as a communications medium. Generally, a peer-to-peer network distributes data across a network of multiple machines for storage and retrieval without the use of a central server or servers. Thus, each peer network node may incorporate the functions of both the client and the server described above.

FIG. 6 shows one example of a conventional computer system that can be used as image acquisition unit. The computer system 600 interfaces to external systems through the modem or network interface 602. It will be appreciated that the modem or network interface 602 can be considered to be part of the computer system 600. This interface 602 can be an analog modem, ISDN modem, cable modem, token ring interface, satellite transmission interface or other interfaces for coupling a computer system to other computer systems. The computer system 602 includes a processing unit 604, which can be a conventional microprocessor such as an Intel Pentium microprocessor or Motorola Power PC microprocessor. Memory 608 is coupled to the processor 604 by a bus 606. Memory 608 can be dynamic random access memory (DRAM) and can also include static RAM (SRAM). The bus 606 couples the processor 604 to the memory 608 and also to non-volatile storage 614 and to display controller 610 to the input/output (I/O) controller 616. The display controller 610 controls in the conventional manner a display on a display device 612 which can be a cathode ray tube (CRT) or liquid crystal display (LCD). The input/output devices 618 can include a keyboard, disk drives, printers, a scanner, and other input and output devices, including a mouse or other pointing device. The display controller 610 and the I/O controller 616 can be implemented with conventional well known technology. A digital image input device 620 can be a digital camera which is coupled to an I/O controller 616 in order to allow images from the digital camera to be input into the computer system 600. The non-volatile storage 614 is often a magnetic hard disk, an optical disk, or another form of storage for large amounts of data. Some of this data is often written, by a direct memory access process, into memory 608 during execution of software in the computer system 600. One of skill in the art will immediately recognize that the terms “computer-readable medium” and “machine-readable medium” include any type of storage device that is accessible by the processor 604 1.

Network computers are another type of computer system that can be used with the embodiments of the present invention. Network computers do not usually include a hard disk or other mass storage, and the executable programs are loaded from a network connection into the memory 608 for execution by the processor 604. A Web TV system, which is known in the art, is also considered to be a computer system according to the embodiments of the present invention, but it may lack some of the features shown in FIG. 6, such as certain input or output devices. A typical computer system will usually include at least a processor, memory, and a bus coupling the memory to the processor.

It will be appreciated that the computer system 600 is one example of many possible computer systems, which have different architectures. For example, personal computers based on an Intel microprocessor often have multiple buses, one of which can be an input/output (I/O) bus for the peripherals and one that directly connects the processor 604 and the memory 608 (often referred to as a memory bus). The buses are connected together through bridge components that perform any necessary translation due to differing bus protocols.

It will also be appreciated that the computer system 600 is controlled by operating system software, which includes a file management system, such as a disk operating system, which is part of the operating system software. One example of an operating system software with its associated file management system software is the family of operating systems known as Windows® from Microsoft Corporation of Redmond, Wash., and their associated file management systems. The file management system is typically stored in the non-volatile storage 614 and causes the processor 604 to execute the various acts required by the operating system to input and output data and to store data in memory, including storing files on the non-volatile storage 614.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computerized method comprising:
receiving focal point and field depth information for an image to be acquired;
analyzing the image based on the focal point and field depth information to calculate characteristics of contents of the image;
determining an image exposure based on the characteristics; and
determining the appropriate aperture and shutter speed based on the field depth information.

2. The computerized method of claim 1, wherein the analyzing the image is further based on analyzing the contents of the image.

3. The computerized method of claim 2, wherein the image content is selected from one of lighting, color, and subject distance.

4. The computerized method of claim 1, wherein the focal point information is any point in the image.

5. The computerized method of claim 1, further comprising:
selecting an image scene based on the characteristics, wherein the selecting the image scene is selected from one of the group comprising snow, twilight, portrait, scenery/landscape building, night scene.

6. The computerized method of claim 1, further comprising:
determining the appropriate flash level setting based on the characteristics.

7. The computerized method of claim 6, wherein the determining the appropriate flash setting is based on the one of an image focus distance and reflectance a subject's surface.

8. A machine readable medium having executable instructions to cause a processor to perform a method comprising:
receiving focal point and field depth information for an image to be acquired;
analyzing the image based on the focal point and field depth information to calculate characteristics of contents of the image;
determining an image exposure based on the characteristics; and
determining the appropriate aperture and shutter speed based on the field depth information.

9. The machine readable medium of claim 1, wherein the analyzing the image is further based on analyzing the contents of the image.

10. The machine readable medium of claim 9, wherein the image content is selected from one of lighting, color, and subject distance.

11. The machine readable medium of claim 1, wherein the focal point information is any point in the image.

12. The machine readable medium of claim 1, wherein the method further comprises:
selecting an image scene based on the characteristics, wherein the selecting the image scene is selected from one of the group comprising snow, twilight, portrait, scenery/landscape building, night scene.

13. The machine readable medium of claim 1, wherein the method further comprises:
determining the appropriate flash level setting based on the characteristics.

14. The machine readable medium of claim 13, wherein the determining the appropriate flash setting is based on the one of an image focus distance and reflectance a subject's surface.

15. An apparatus comprising:
means for receiving focal point and field depth information for an image to be acquired;
means for analyzing the image based on the focal point and field depth information to calculate characteristics of contents of the image;
means for determining an image exposure based on the characteristics; and
means for determining the appropriate aperture and shutter speed based on the field depth information.

16. The apparatus of claim 15, further comprising:
means for selecting an image scene based on the characteristics, wherein the selecting the image scene is selected from one of the group comprising snow, twilight, portrait, scenery/landscape building, night scene.

17. The apparatus of claim 15, further comprising:
means for determining the appropriate flash level setting based on the characteristics.

18. A system comprising:
a processor;
a memory coupled to the processor though a bus; and
a process executed from the memory by the processor to cause the processor to receive focal point and field depth information for an image to be acquired, analyze the image based on the focal point and field depth information to calculate characteristics of contents of the image, determine an image exposure based on the characteristics, and determine the appropriate aperture and shutter speed based on the field depth information.

19. The system of claim 18, wherein the process further causes the processor to select an image scene based on the characteristics, wherein the selecting the image scene is selected from one of the group comprising snow, twilight, portrait, scenery/landscape building, night scene.

20. The system of claim 18, wherein the process further causes the processor to determine the appropriate flash level setting based on the characteristics.
